(19) United States
(12) Patent Application Publication
(10) Pub. No.: US 2022/0269239 A1
(43) Pub. Date: Aug. 25, 2022

(54) INFORMATION PROCESSING APPARATUS, CONTROL APPARATUS, CONTROL METHOD, METHOD OF CONTROLLING CONTROL APPARATUS, AND RECORDING MEDIUM

(71) Applicant: CANON KABUSHIKI KAISHA, Tokyo (JP)

(72) Inventors: Keisuke Ito, Kanagawa (JP); Masaki Fujita, Tokyo (JP)

(21) Appl. No.: 17/668,479

(22) Filed: Feb. 10, 2022

(30) Foreign Application Priority Data
Feb. 25, 2021 (JP) 2021-028076
Jan. 13, 2022 (JP) 2022-003582

(51) Int. Cl. G05B 19/05

(52) U.S. Cl. CPC G05B 19/056; G05B 2219/13197; G05B 2219/13004

(57) ABSTRACT

An information processing apparatus includes a display portion, a storage portion, and a processing portion. The processing portion is configured to display an operation-process identifying information that indicates an operation process of a plurality of operation processes, and a figure information that represents a flow-path structure, on the display portion. The processing portion is configured to display a flow-path portion used as a flow path of the flow-path structure in an operation process indicated by the operation-process identifying information, on the display portion by using the figure information. The processing portion is configured to associate the flow-path portion with the operation-process identifying information and store the flow-path portion associated with the operation-process identifying information, in the storage portion, as flow-path setting information.

### BACKGROUND OF THE INVENTION

### Field of the Invention

The present invention relates to an information processing apparatus. In particular, the present invention relates to an information processing apparatus used when an apparatus having a flow-path structure including a plurality of flow-path portions sets or performs a series of operations.

### Description of the Related Art

In a field, such as a water treatment system or a chemical plant, that uses fluid, an apparatus including a flow-path structure is known. The flow-path structure includes pumps, valves, pipes, tanks, and reaction tanks. In such an apparatus, a variety of types of chemical treatment or physical treatment is performed by using fluid material. The flow path of the fluid material is appropriately opened or closed, or otherwise changed, depending on the treatment. For automating the operation of the apparatus, operations of components, such as pumps and valves, of the apparatus need to be controlled by a computer. Thus, a control program executed by the computer needs to be prepared in advance.

If the control program for the apparatus is created and implemented manually, it will take a long time and easily cause errors. For this reason, Japanese Patent Application Publication No. 2011-198237 discloses a technique that automatically creates and implements a control program by using setting data in which an input/output signal list and a sequence flow are defined.

In recent years, however, as such as apparatus has more functions and more complicated processes, the flow-path structure tends to be more complicated. In addition, it may have to be determined which portion of the flow-path structure is used in a process performed by the apparatus. For example, suppose that there are a path 1 and a path 2 in the flow-path structure of the apparatus, for moving a fluid material stored in a tank A to a reaction tank B. Note that an optimum path used as a flow path in each process is not necessarily determined by only physical specifications, such as a length and a thickness of the path. That is, it is necessary that the optimum path is determined in consideration of the influence (e.g., residual temperature distribution) exerted from a preceding or following process and the relationship (e.g., mutual interference) between the optimum path and another path used in another process performed in parallel with the process. For example, the path 1 may be suitably used when a chemical process C is performed in the reaction tank B in a first process, and the path 2 may be suitably used when a chemical process D is performed in the reaction tank B in a second process.

As described above, Japanese Patent Application Publication No. 2011-198237 discloses a technique that automatically creates and implements a control program by using setting data in which an input/output signal list and a sequence flow are defined. However, setting of the above-described optimum path in the creation of the setting data is not achieved in the technique. Thus, the conventional information processing apparatus that sets or performs the operation of the apparatus, which includes the flow-path structure, fails to allow a worker to easily set an optimum flow path for each process performed by the apparatus.

### SUMMARY OF THE INVENTION

According to a first aspect of this disclosure, there is provided an information processing apparatus including a display portion, a storage portion, and a processing portion. The processing portion is configured to display an operation-process identifying information that indicates an operation process of a plurality of operation processes, and a figure information that represents a flow-path structure, on the display portion. The processing portion is configured to display a flow-path portion used as a flow path of the flow-path structure in an operation process indicated by the operation-process identifying information, on the display portion by using the figure information. The processing portion is configured to associate the flow-path portion with the operation-process identifying information and store the flow-path portion associated with the operation-process identifying information, in the storage portion, as flow-path setting information.

According to a second aspect of this disclosure, there is provided a control method including acquiring, by a computer, information on a flow-path structure of a controlled apparatus and information on a plurality of operation processes executed by the controlled apparatus, displaying, by the computer, figure information that represents the flow-path structure, on a display portion, and storing, by the computer, a flow-path portion as flow-path setting information for each of a plurality of operation processes executed by the controlled apparatus, the flow-path portion being used as a flow path of the flow-path structure.

Further features of the present invention will become apparent from the following description of exemplary embodiments with reference to the attached drawings.

### BRIEF DESCRIPTION OF THE DRAWINGS

FIG. 1 is a schematic diagram for illustrating a configuration and functions of a program generation system 1 of an embodiment.

FIG. 2 is a diagram for illustrating a process operation table 2 of an embodiment.

FIG. 3 is a diagram for illustrating a piping-diagram data 3 of an embodiment.

FIG. 4 is a diagram for illustrating a data reading screen 42 of an embodiment.

FIG. 5 is a diagram for illustrating a program-output setting screen 400 of an embodiment.

FIG. 6 is a diagram for illustrating a diagram selecting screen 44 of an embodiment.

FIG. 7 is a diagram for illustrating a flow-path setting screen 41 of an embodiment.

FIG. 8 is a diagram for illustrating an input/output-signal setting screen 43 of an embodiment.

FIG. 9 is a diagram for illustrating a flow-path information 55 of an embodiment.

FIG. 10 is a diagram for illustrating a symbol type information 53 of an embodiment.

FIG. 11 is a diagram for illustrating a symbol information 58 of an embodiment.

FIG. 12 is a diagram for illustrating an internal device information 54 of an embodiment.

FIG. 13 is a diagram for illustrating a program component information 56 of an embodiment.

FIG. 14 is a diagram for illustrating a control device information 57 of an embodiment.

FIG. 15 is a diagram for illustrating a control program information 59 of an embodiment.

FIG. 16 is a flowchart illustrating a basic procedure of a program generation method of an embodiment.

FIG. 17 is a flowchart illustrating a procedure of a data reading process of an embodiment.

FIG. 18A is a diagram illustrating a state where a flow path is being set in an embodiment.

FIG. 18B is a diagram illustrating a state where the graphic formation of the flow path is completed in an embodiment.

FIG. 19 is a flowchart illustrating a procedure of a generation process of a flow-path information 55 of an embodiment.

FIG. 20 is a flowchart illustrating a procedure of an input/output-signal generation process of an embodiment.

FIG. 21 is a flowchart illustrating a procedure of a control-program generation process of an embodiment.

FIG. 22 is a sub-flowchart illustrating a procedure of a control-program generation subroutine of an embodiment.

FIG. 23 is a sub-flowchart illustrating a procedure of a device-address setting subroutine of an embodiment.

FIG. 24 is a diagram for illustrating a program-output setting screen 400A of a modification.

FIG. 25 is a flowchart illustrating a procedure of the graphic formation of a timing chart of a modification.

FIG. 26 is a diagram illustrating a state where a flow path is being graphically formed in setting of flow path of a modification.

### DESCRIPTION OF THE EMBODIMENTS

Hereinafter, a program generation system, a program generation method, and the like will be described with reference to the accompanying drawings. The program generation system is one example of information processing apparatuses of an embodiment of the present invention. Note that in the drawings that will be referred to in the following embodiments, a component given an identical reference numeral has an identical function, unless otherwise specified.

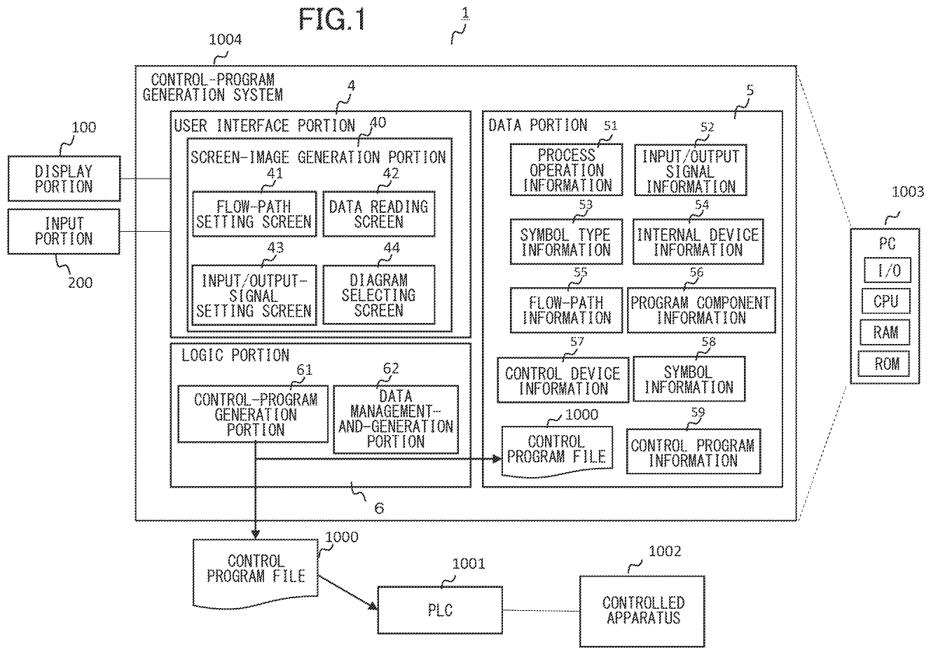

FIG. 1 is a schematic diagram for illustrating a configuration and functions of a program generation system 1, which is one example of information processing apparatuses of an embodiment of the present invention. Note that in FIG. 1, the blocks represent elements that are necessary for describing features of the present embodiment. Thus, other elements that are commonly used and that are not directly related to the principle of the present invention for solving the problem are not illustrated. In addition, since the elements of FIG. 1 are illustrated conceptually so that the functions of the elements can be understood, the elements may not necessarily be connected with each other physically as illustrated in FIG. 1. For example, a specific configuration in which the blocks are distributed or combined is not limited to the example illustrated in the figure, and part or all of the blocks may be functionally or physically distributed or combined in a predetermined unit, in accordance with a use state or the like.

As illustrated in FIG. 1, the program generation system 1 of the embodiment includes a display portion 100, an input portion 200, and a PC 1003. The block illustrated in FIG. 1 as a control-program generation system 1004 schematically illustrates functions that are executed by the PC 1003 performing a processing program, and data that is used when the processing program is executed. The function blocks of the control-program generation system 1004 can be achieved by using hardware or software. For example, the function blocks can be achieved by a CPU reading and executing a control program stored in a storage device or a non-transitory recording medium. In another case, part or all of the function blocks may be achieved by a hardware component, such as an ASIC, included in the control-program generation system 1004.

The program generation system 1 generates a control program file 1000. The control program file 1000 is a control program executed by a programmable logic controller (PLC) 1001 when the PLC 1001 controls the operation of a controlled apparatus 1002 (e.g., an industrial plant). The PLC 1001 is one example of control apparatuses.

The PC 1003 of the program generation system 1 includes a CPU that serves as a central processing unit, a ROM and a RAM that serve as memory units, and an I/O that serves an input/output interface. The CPU, the ROM, the RAM, and the I/O are hardware components. The ROM stores a processing program that achieves a later-described information processing method. The RAM is used, for example, as a work area of the CPU when the CPU performs the information processing method. In addition, the PC 1003 can be connected with a variety of external storage devices (not illustrated), such as an HDD, an SSD, and a network-mounted external storage device of another system; and can use the external storage devices as a storage portion, as well as the ROM and the RAM.

The processing program that achieves the program generation system 1 of the embodiment and that executes the program generation method can be stored in the ROM of the PC 1003, or in an external storage device such as an HDD or an SSD. In another case, the processing program may be supplied to the above-described storage portion via a computer-readable recording medium, such as an optical disk, a magneto-optical disk, a magnetic tape, a USB memory, or an SSD. The processing program supplied to the storage portion can be updated. In another case, the processing program may be written in the above-described storage portion via a network and the I/O.

The display portion 100 is a device that displays later-described various types of information for an operator when the program generation system 1 executes the program generation method. For example, the display portion 100 is a liquid-crystal display apparatus or an organic-electroluminescent display apparatus. The input portion 200 is a device that an operator uses for inputting various types of instruction and information when the program generation system 1 executes the program generation method. For example, the input portion 200 is a keyboard, a jog dial, a mouse, a pointing device, or a voice input device. Next, functions achieved by the PC 1003 executing the processing program, and data used by the PC 1003 when the PC 1003 executes the processing program will be described with reference to FIG. 1.

### Control-Program Generation Portion

The control-program generation system 1004 includes a user interface portion 4, a data portion 5, and a logic portion 6. Hereinafter, the user interface portion 4, the data portion 5, and the logic portion 6 will be described sequentially.

### User Interface Portion

The user interface portion 4 displays a variety of types of information on the display portion 100, and receives a variety of types of information and instructions through the input portion 200. The user interface portion 4 includes a screen-image generation portion 40 that generates screen-image information to be displayed on the display portion 100. When the program generation method is executed, the screen-image generation portion 40 supplies a predetermined type of screen-image information to the display portion 100 in accordance with execution phase. Specifically, the screen-image generation portion 40 supplies screen-image information, such as a flow-path setting screen 41, a data reading screen 42, an input/output-signal setting screen 43, and a diagram selecting screen 44, to the display portion 100. These types of screen-image information are displayed on the display portion 100 for receiving setting data via the input portion 200. The setting data is related to a process operation table 2, a piping-diagram data 3, a flow path 30, a device address 70, and the like, which will be described later. Note that the configuration of the screen-image generation portion 40 is not limited to the above-described example. For example, in accordance with the user operability, screen images may be joined with each other, or one screen image may be separated from or added to another.

### Data Portion

The data portion 5 is allocated to the storage portion of the PC 1003; and stores a variety of types of information (51 to 58) used for executing the program generation method, and a control program information 59 that is a product obtained by executing the program generation method. In addition, the data portion 5 may store a control program file 1000 (e.g., ladder program), into which the control program information 59 is converted and which has a format that can be executed by the PLC 1001. The variety of types of information stored in the data portion 5 includes a process operation information 51, an input/output signal information 52, a symbol type information 53, an internal device information 54, a flow-path information 55, a program component information 56, a control device information 57, and a symbol information 58. Note that the configuration of the data portion 5 is not limited to the above-described configuration. For example, for the ease of maintenance, types of information may be joined with each other, one type of information may be separated from another, or log information on user operation may be added.

### Logic Portion

When the program generation method is executed, the logic portion 6 manages the variety of types of data stored in the data portion 5, and generates the control program information 59, which is a product, and the control program file 1000. A data management-and-generation portion 62 included in the logic portion 6 stores the information in the data portion 5 and reads the information from the data portion 5, while managing the association of ID between the variety of types of information stored in the data portion 5. In addition, a control-program generation portion 61 included in the logic portion 6 generates the control program information 59 which is a product, and the control program file 1000 into which the control program information 59 is converted and which has a format that can be executed by the PLC 1001.

### Data Table and Displayed Screen

Next, the variety of types of information (table) displayed on the display portion 100 and screens operated by a user will be described. The variety of types of information (table) and the screens are displayed and operated when the program generation method of an embodiment is executed.

### Process Operation Table

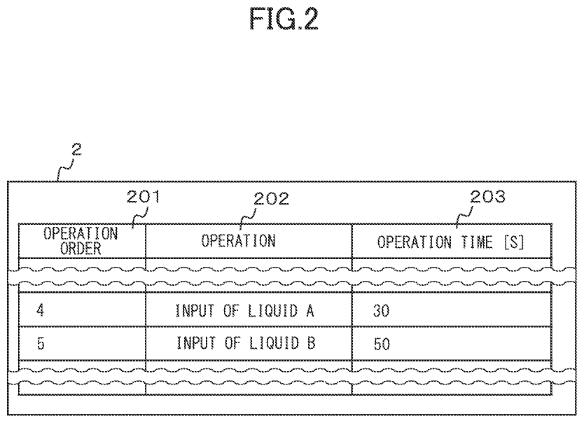

First, a configuration of a process operation table 2 will be described with reference to FIG. 2. The process operation table 2 is a table in which a procedure of operations executed by a controlled apparatus 1002 is written. The process operation table 2 may be stored in the process operation information 51 of the data portion 5 by the data management-and-generation portion 62. The process operation table 2 includes an operation order 201, an operation 202, and an operation time 203. One line of the process operation table 2 in the lateral direction corresponds to one operation process to be executed by the controlled apparatus 1002. Numbers that are set in the operation order 201 identify the respective operation processes and indicate the order of operation processes to be executed. The operation 202 indicates the outline of each operation to be executed by the controlled apparatus 1002 in a corresponding operation process. The operation time 203 indicates the execution time of each operation indicated by the operation 202. Note that the configuration of the process operation table 2 is not limited to the above-described configuration. For example, various parameters related to the operation 202 may be added to the process operation table 2. With the process operation table 2 displayed on the display portion 100, a user can set, check, or change the procedure of operations to be executed by the controlled apparatus 1002.

### Piping-Diagram Data

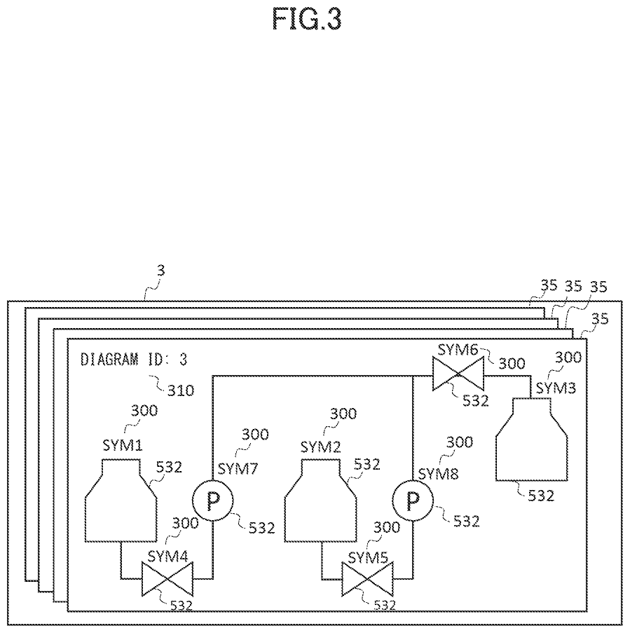

With reference to FIG. 3, a piping-diagram data 3 will be described. The controlled apparatus 1002 has a flow-path structure that includes a plurality of flow-path portions. Thus, the piping-diagram data 3 includes piping diagrams 35 that illustrate the flow-path structure as figure information. Note that although a simple flow-path structure is illustrated in FIG. 3 for convenience of illustration, the piping diagrams 35 represent a complicated flow-path structure, depending on the controlled apparatus 1002. The piping diagrams 35 are created in accordance with the respective operation processes of the controlled apparatus 1002 as described later, and thus the number of the piping diagrams 35 is the same as the number of the operation processes. The piping-diagram data 3 is a collection of the piping diagrams 35. Each of the piping diagrams 35 includes a piping-diagram ID 310, symbol IDs 300, a plurality of symbols 532, and a plurality of pipes.

As described above, the number of the piping diagrams 35 is the same as the number of the operation processes. Thus, the piping-diagram ID 310 is an ID for identifying a corresponding piping diagram 35. In other words, the piping-diagram ID 310 is operation-process identifying information that indicates a corresponding one of a plurality of operation processes. The data management-and-generation portion 62 creates diagram management information in which a piping diagram 35 is associated with a corresponding piping-diagram ID 310, and stores the diagram management information in the data portion 5.

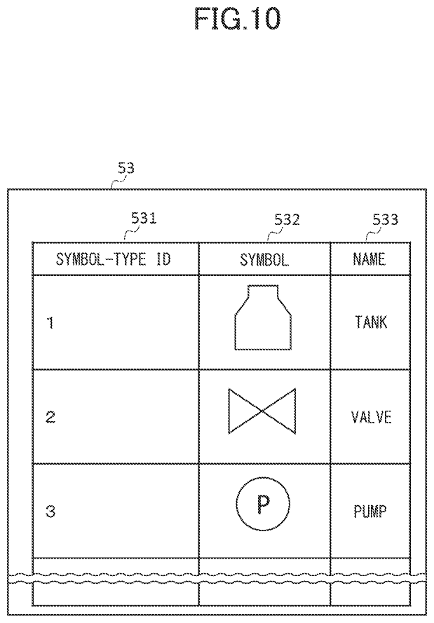

The symbols 532 are figures representing components of the flow-path structure. For example, as illustrated in FIG. 10, different figures are used for representing different components, such as tanks, valves, and pumps. Preferably, the figures are formed for a user (worker) to intuitively understand the type and function of each component. Note that the components include controlled components (controlled devices), such as a pump and a valve, operations of which are controlled by the PLC 1001. The controlled devices include a device that changes its state during one operation process. For example, a valve may be opened and closed several times during one operation process. The symbol ID 300 is ID information for individually identifying a component of the flow-path structure.

### Data Reading Screen

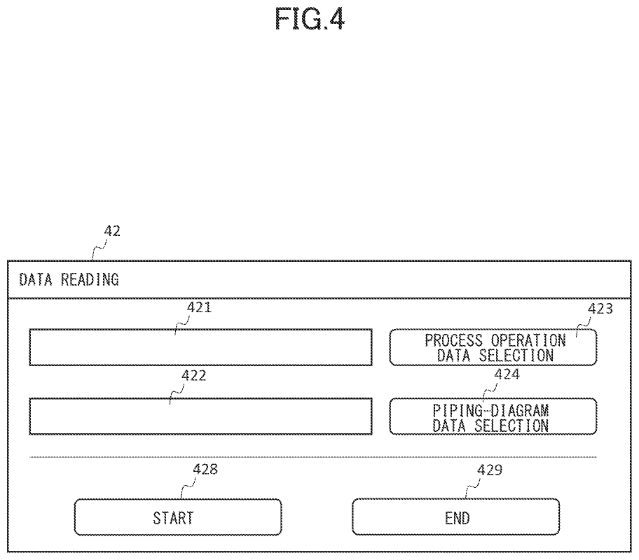

With reference to FIG. 4, the data reading screen 42 will be described. The data reading screen 42 is a screen that receives an operation of a user when the user desires to operate the process operation table 2 or the piping-diagram data 3. The data reading screen 42 includes a process-operation-data-path input box 421, a piping-diagram-data-path input box 422, a process-operation-data-selection dialog button 423, a piping-diagram-data-selection dialog button 424, a system start button 428, and a system end button 429.

The process-operation-data-path input box 421 is an input box used for inputting a path that indicates a location where the electronic data of the process operation table 2 is stored. The piping-diagram-data-path input box 422 is an input box used for inputting a path that indicates a location where the electronic data of the piping-diagram data 3 is stored. The process-operation-data-selection dialog button 423 is a button to display a dialog used for searching or navigating for a path that indicates a location where the electronic data of the process operation table 2 is stored. The piping-diagram-data-selection dialog button 424 is a button to display a dialog used for searching or navigating for a path that indicates a location where the electronic data of the piping-diagram data 3 is stored. When the system start button 428 is clicked, data is read from the location indicated by the path inputted in the process-operation-data-path input box 421, and from the location indicated by the path inputted in the piping-diagram-data-path input box 422, and the screen transitions to a later-described program-output setting screen 400. When the system end button 429 is clicked, the process of the control-program generation system 1004 is discontinued and shut down.

### Program-Output Setting Screen

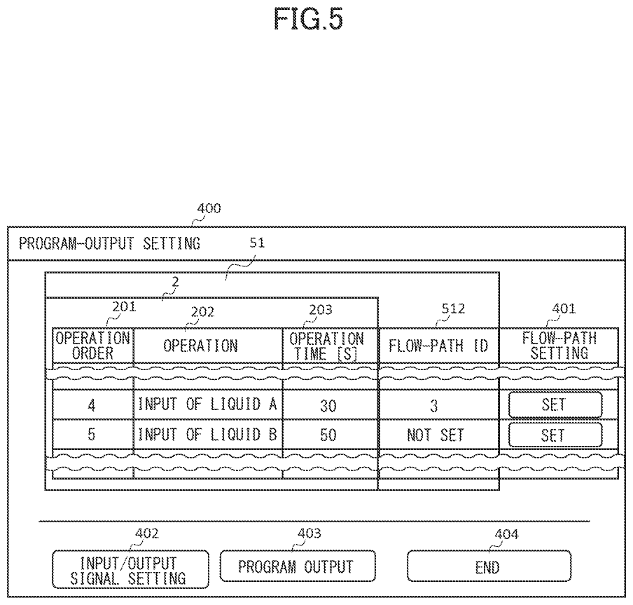

With reference to FIG. 5, the program-output setting screen 400 will be described. The program-output setting screen 400 is a screen for a user to set a flow-path ID 512 to the above-described process operation table 2. The program-output setting screen 400 includes a process operation information 51, a flow-path setting button 401, an input/output-signal setting button 402, a program output button 403, and a program-output-setting end button 404. The process operation information 51 includes the process operation table 2 and the flow-path ID 512. The flow-path ID 512 is an ID that is given to each flow path. As described in detail later, a flow path is a portion of the flow-path structure that is used when the controlled apparatus 1002 is operated, and that is identified for each operation process.

The flow-path setting button 401 is disposed for each record of the process operation information 51. When the flow-path setting button 401 is clicked, the screen transitions to a later-described diagram selecting screen 44. When the input/output-signal setting button 402 is clicked, the screen transitions to a later-described input/output-signal setting screen 43. When the program output button 403 is clicked, the control-program generation portion 61 stores the control program information 59, which is a product, in the data portion 5; and then, the control-program generation portion 61 generates the control program file 1000 (e.g., ladder program), into which the control program information 59 is converted and which has a format that can be executed by the PLC 1001, and outputs the control program file 1000 to the external device. When the program-output-setting end button 404 is clicked, the program-output setting process is discontinued, and the screen transitions to the above-described data reading screen 42.

### Diagram Selecting Screen

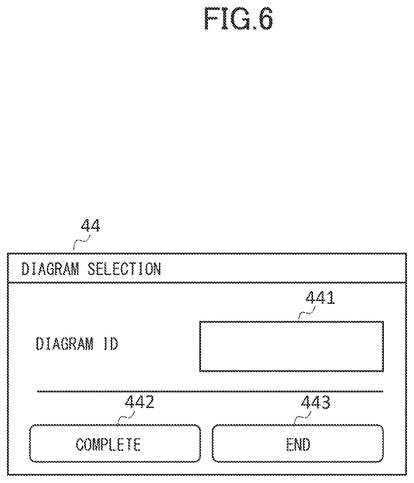

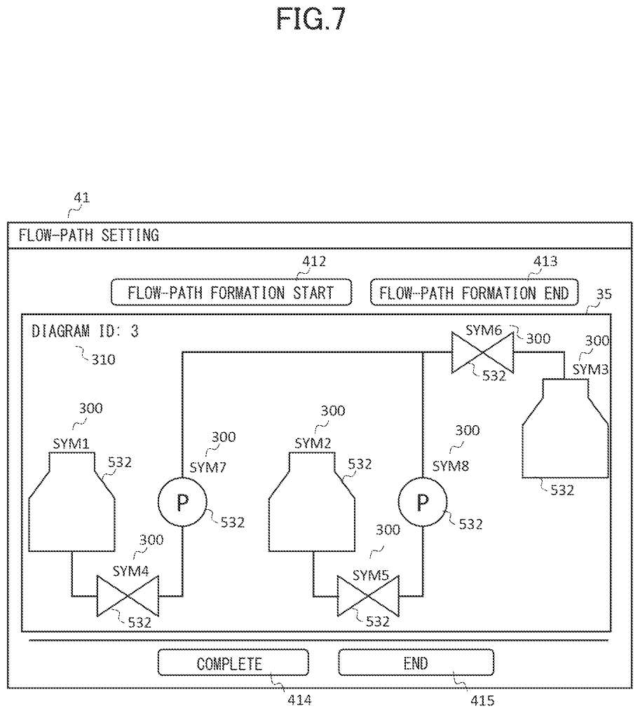

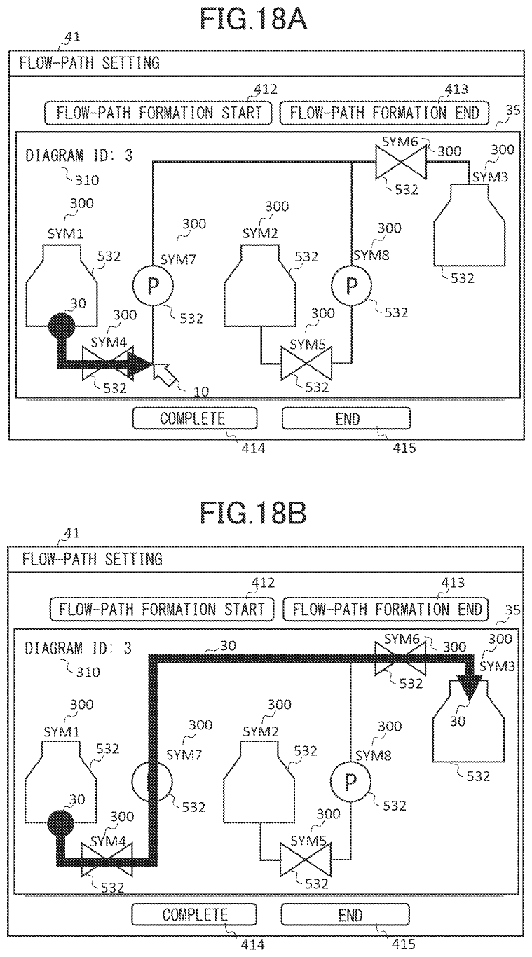

With reference to FIG. 6, the diagram selecting screen 44 will be described. As described later with reference to FIG. 18 as an example, a user sets a flow path in a piping diagram 35, which corresponds to an operation process. The diagram selecting screen 44 is a screen for calling the piping diagram 35 when a user sets the flow path. The diagram selecting screen 44 includes a diagram-ID input box 441, a diagram-selection completion button 442, and a diagram-selection end button 443. The diagram-ID input box 441 is an input box for inputting a piping-diagram ID 310 (see FIG. 7). When the diagram-selection completion button 442 is clicked, the screen transitions to the flow-path setting screen 41 (see FIG. 7) on which a piping diagram 35 with a specified piping-diagram ID 310 is superimposed.

### Flow-path Setting Screen

With reference to FIG. 7, the flow-path setting screen 41 will be described. A user sets a portion (i.e., flow path) of the flow-path structure, for each of the operation processes written in the process operation table (FIG. 2). The flow-path setting screen 41 is a screen called via the above-described diagram selecting screen 44 and displayed on the display portion 100 when a user sets a portion of the flow-path structure. The flow-path setting screen 41 includes the piping diagram 35, a flow-path-formation start button 412, a flow-path-formation end button 413, a flow-path-setting completion button 414, and a flow-path-setting end button 415.

When the flow-path-formation start button 412 is clicked, the graphic formation of a flow path 30 in the piping diagram 35 is started. When the flow-path-formation end button 413 is clicked, the graphic formation of the flow path 30 in the piping diagram 35 is ended. When the flow-path-setting completion button 414 is clicked, the process of a later-described flow-path-process-operation flowchart is started. When the flow-path-setting end button 415 is clicked, the flow-path setting process is discontinued, and the screen transitions to the diagram selecting screen 44.

### Input/Output-Signal Setting Screen

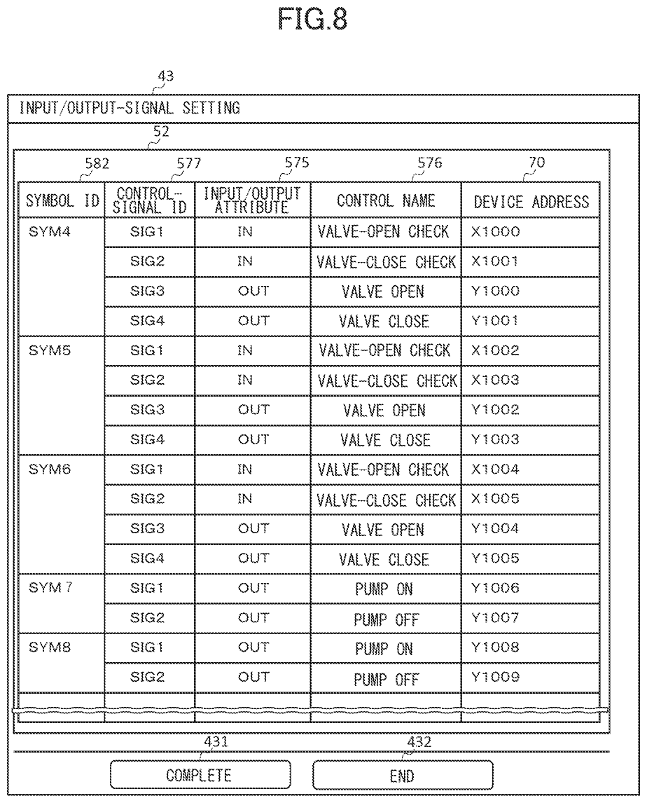

With reference to FIG. 8, the input/output-signal setting screen 43 will be described. Of the components given the symbol ID 300 in the piping-diagram data 3 of FIG. 3, some components receive or send control signals. The input/output-signal setting screen 43 is a screen used for associating the component with a corresponding control-signal ID 577 and a corresponding device address 70. The input/output-signal setting screen 43 includes an input/output signal information 52, an input/output-signal-setting completion button 431, and an input/output-signal-setting end button 432. The input/output signal information 52 includes a symbol ID 582, the control-signal ID 577, an input/output attribute 575, a control name 576, and the device address 70.

The control-signal ID 577 is given to each of input/output signal terminals of a component identified by the symbol ID 582. The input/output signal terminals are used for controlling the component. The input/output attribute 575 represents an input/output direction of the control-signal ID 577. If the input/output attribute 575 is “IN”, the terminal is an input signal terminal; if the input/output attribute 575 is “OUT”, the terminal is an output signal terminal. The control name 576 is a character string that represents a role of the control signal ID. The device address 70 is an address assigned to a signal of the programmable logic controller (PLC). When the input/output-signal-setting completion button 431 is clicked, the device address 70 is stored in the input/output signal information 52. When the input/output-signal end button 432 is clicked, the input/output signal setting process is discontinued, and the screen transitions to the program-output setting screen 400.

### Flow-Path Information

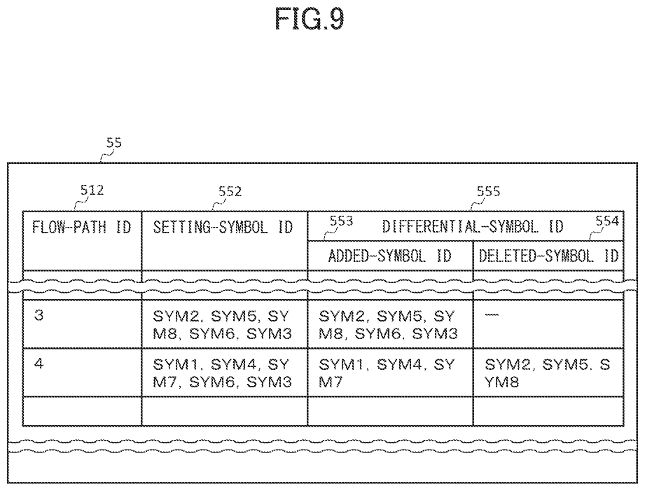

With reference to FIG. 9, the flow-path information 55 (flow-path information table) will be described. The flow-path information 55 includes a flow-path ID 512, a setting-symbol ID 552, and a differential-symbol ID 555. One line of the flow-path information table in the lateral direction corresponds to a flow path used for one operation process to be executed by the controlled apparatus 1002. Thus, the flow-path ID 512 can identify a flow path used for a corresponding operation process. In other words, the flow-path information 55 is flow-path setting information that associates a flow-path portion with a corresponding operation-process identifying information.

The setting-symbol ID 552 is a collection of symbol IDs 582 that exist on a flow path. The differential-symbol ID 555 includes an added-symbol ID 553 and a deleted-symbol ID 554. The differential-symbol ID 555 represents the difference between a setting-symbol ID 552 corresponding to one flow-path ID 512 and a setting-symbol ID 552 corresponding to another flow-path ID 512 that is immediately before the one flow-path ID 512 (that is, the flow path indicated by the other flow-path ID 512 is the flow path that is immediately before the flow path indicated by the one flow-path ID 512).

The added-symbol ID 553 represents setting symbols added from the setting-symbol ID 552 corresponding to the previous flow-path ID 512, to the setting-symbol ID 552 corresponding to the one flow-path ID 512. The deleted-symbol ID 554 represents setting symbols deleted from the setting-symbol ID 552 corresponding to the previous flow-path ID 512, in the setting-symbol ID 552 corresponding to the one flow-path ID 512. In the example of FIG. 9, in comparison between the setting-symbol ID 552 corresponding to a flow-path ID 512 of 4, and the setting-symbol ID 552 corresponding to a flow-path ID 512 of 3, symbol IDs SYM1, SYM4, and SYM 7 are added, and symbol IDs SYM 2, SYM 5, and SYM 8 are deleted.

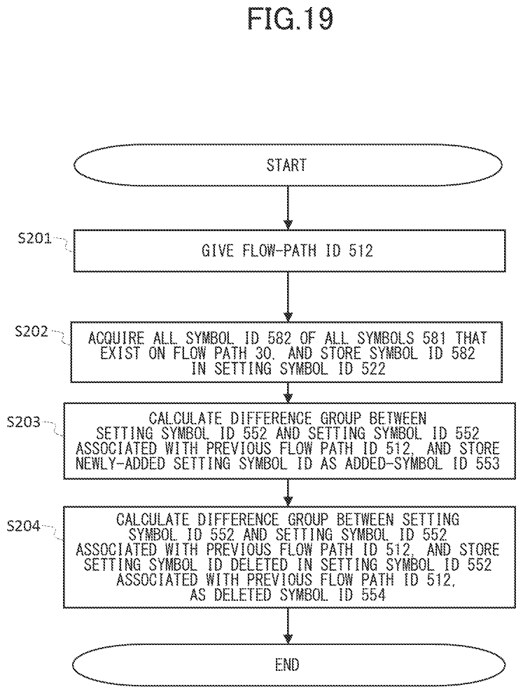

Note that the added-symbol ID 553 is a collection of symbol IDs 582 obtained in S203 of the later-described flow-path-process-operation flowchart (FIG. 19). In addition, the deleted-symbol ID 554 is a collection of symbol IDs 582 obtained in S204 of the flow-path-process-operation flowchart.

### Symbol Type Information

With reference to FIG. 10, the symbol type information 53 (symbol-type-information table) will be described. One line of the symbol-type-information table in the lateral direction corresponds to one type of components of the flow-path structure. Thus, the type of components can be identified by the symbol-type ID 531. That is, the symbol-type ID 531 is ID information that identifies the type of each component of the flow-path structure. A symbol 532 indicates the shape of a figure that corresponds to a type of components, and that is used in the piping-diagram data 3 (FIG. 3) for representing the corresponding component. A name 533 represents a type of components.

### Symbol Information

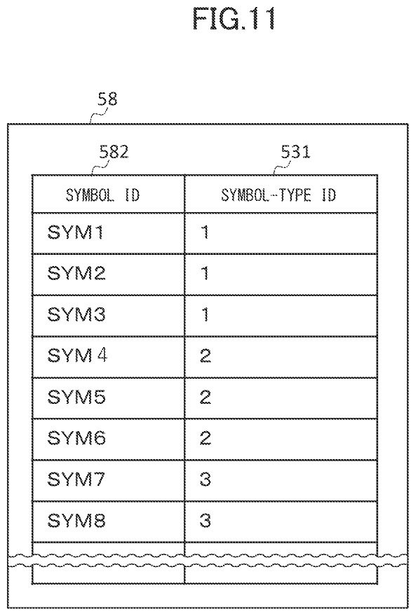

With reference to FIG. 11, the symbol information 58 (symbol-information table) will be described. One line of the symbol-information table in the lateral direction corresponds to one component of the flow-path structure. Thus, the component can be identified by the symbol ID 582. The symbol information 58 indicates the relationship between the symbol ID 582 (FIG. 8) and the symbol-type ID 531 (FIG. 10).

### Internal Device Information

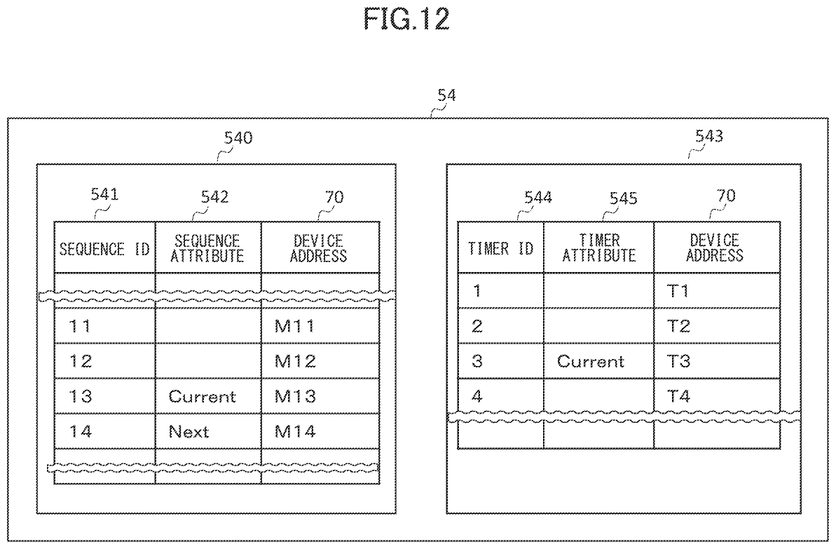

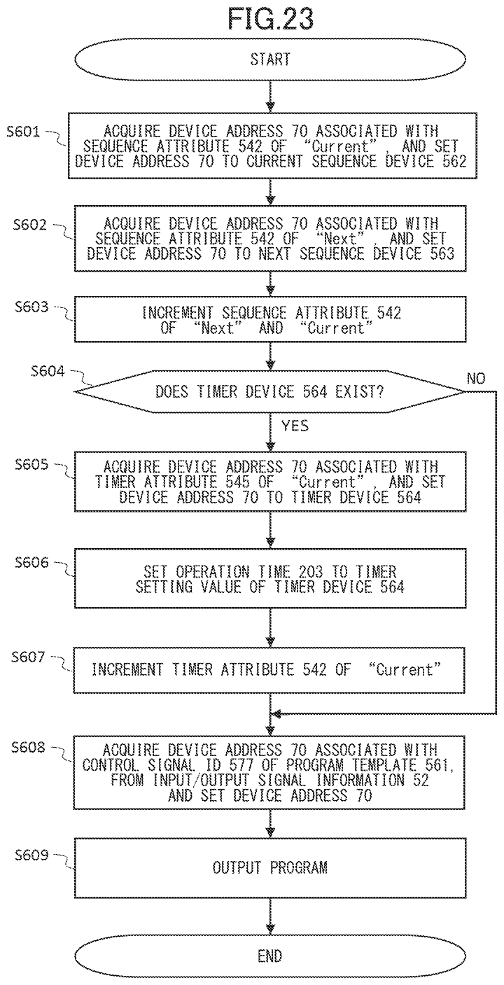

With reference to FIG. 12, the internal device information 54 (internal-device-information table) will be described. The internal device information 54 is information used in a later-described device-address setting process (FIG. 23), and includes a sequence-device information 540 and a timer-device information 543.

The sequence-device information 540 includes a sequence ID 541, a sequence attribute 542, and the device address 70. The sequence ID 541 is a unique number given to each record of the sequence-device information 540. The sequence attribute 542 is information indicating a process state and used in S601 to S603 of the later-described device-address setting flowchart (FIG. 23).

The timer-device information 543 includes a timer ID 544, a timer attribute 545, and the device address 70. The timer ID 544 is a unique number given to each record of the timer-device information 543. The timer attribute 545 is information indicating a process state and used in S605 to S607 of the later-described device-address setting flowchart (FIG. 23).

### Program Component Information

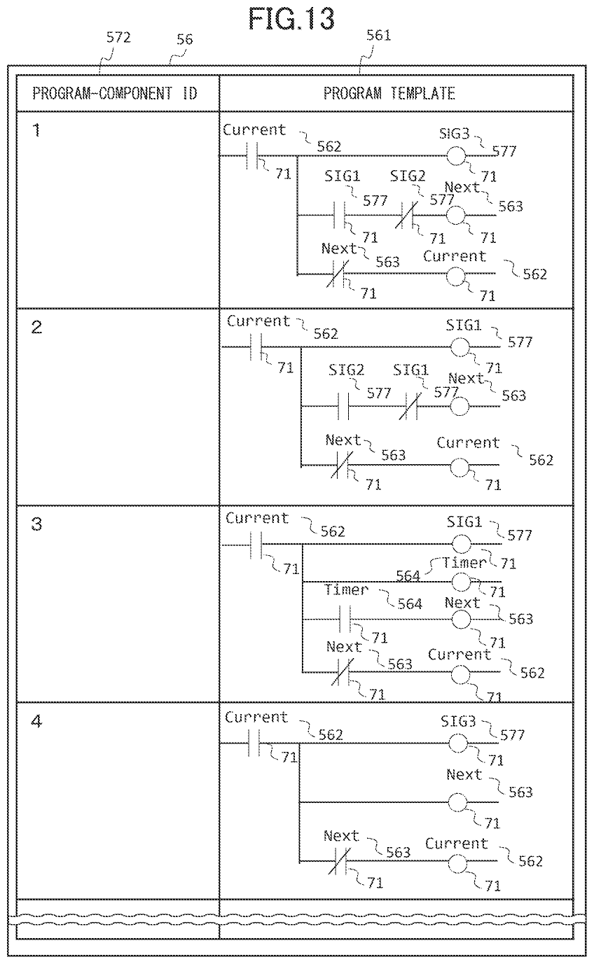

With reference to FIG. 13, the program component information 56 (program-component-information table) will be described. One record of the program-component-information table (i.e., one line in the lateral direction) corresponds to one type of program templates. Thus, a program template can be identified by a program-component ID 572. The program component information 56 includes the program-component ID 572 and a program template 561. The program-component ID 572 is a unique number given to each record of the program component information 56.

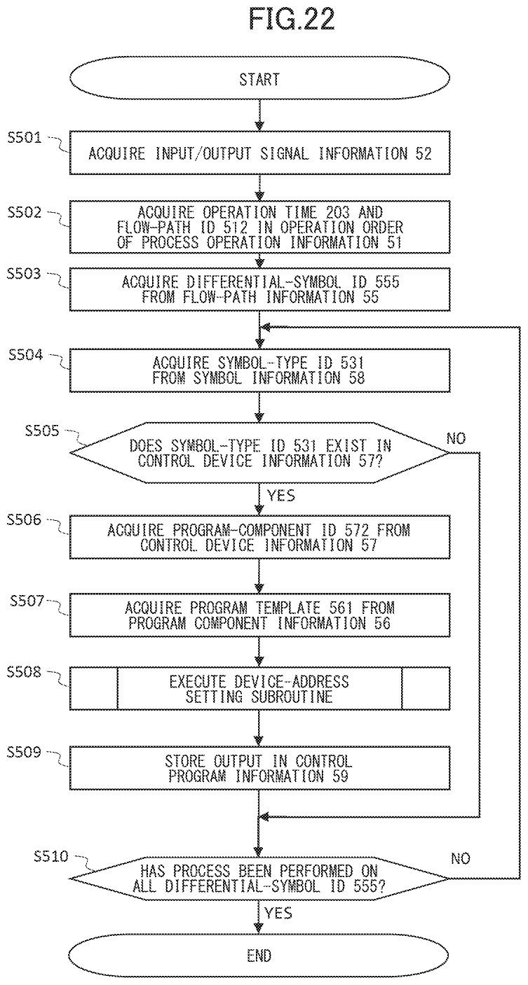

The program template 561 is a library that expresses a control program used in S509 of a later-described control-program generation flowchart (FIG. 22) and written in a ladder (LD) language. The program template 561 includes a ladder symbol 71, a current sequence device 562, a next-time device address 563, a timer device 564, and a control-signal ID 577. The ladder symbol 71 is a figure that expresses a component, such as a contact or a coil, that is used in the ladder (LD) language. The current sequence device 562, the next-time device address 563, and the timer device 564 are variables that are respectively used for setting the device address 70 in S601, S602, and S605 of the later-described device-address setting flowchart (FIG. 23). Note that the program template 561 may not be written in the ladder (LD) language. For example, the program template 561 may be a library written in an instruction list (IL) language or a sequential function chart (SFC) language.

### Control Device Information

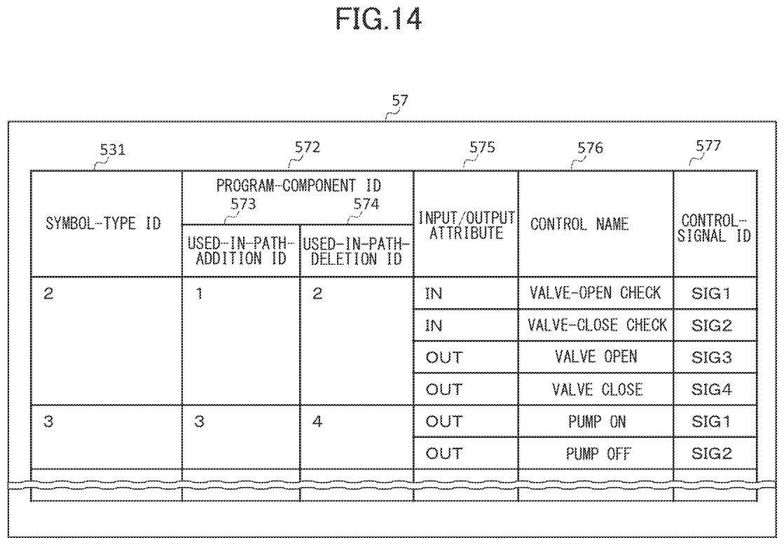

With reference to FIG. 14, the control device information 57 (control-device-information table) will be described. The control device information 57 includes the symbol-type ID 531, the program-component ID 572, the input/output attribute 575, the control name 576, and the control-signal ID 577. The program-component ID 572 includes a used-in-path-addition ID 573 and a used-in-path-deletion ID 574. The used-in-path-addition ID 573 and the used-in-path-deletion ID 574 are program-component IDs 572 referred to in S509 of the later-described control-program generation flowchart (FIG. 22).

### Control Program Information

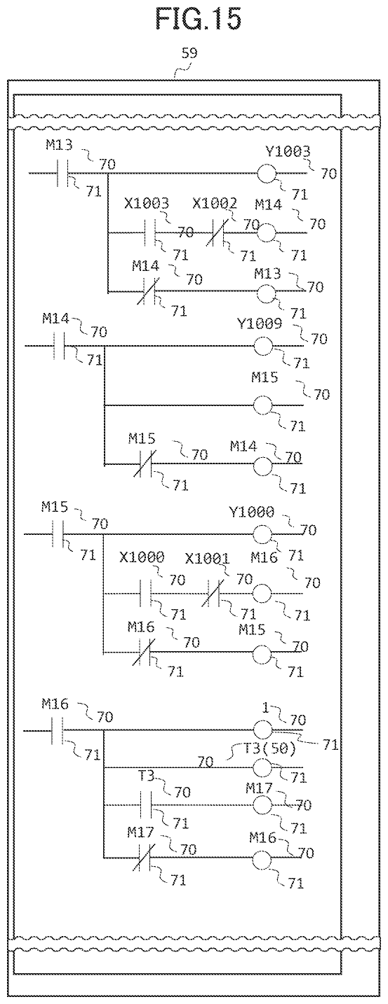

With reference to FIG. 15, the control program information 59 will be described. The control program information 59 is generated by the control-program generation portion 61, as a product from the program generation process. The control program information 59 includes the device address 70 and the ladder symbol 71. The control-program generation system 1004 converts the control program information 59 to the control program file 1000 that has a format that can be interpreted by the PLC 1001, and outputs the control program file 1000. The PLC 1001 executes the control program file 1000, so that the controlled apparatus 1002 executes the operation that is set in the process operation table 2.

### Program Generation Method

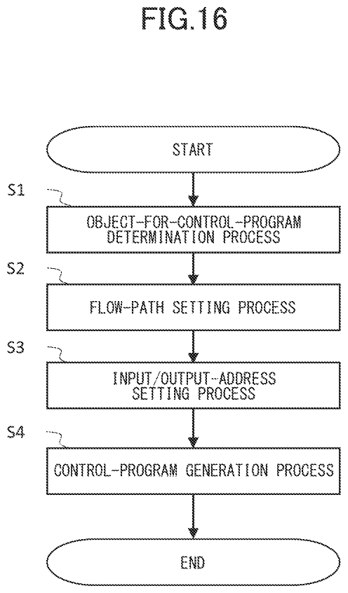

Next, a procedure of processes of a program generation method of an embodiment will be described. FIG. 16 is a flowchart illustrating a basic procedure in the program generation method. First, in an object-for-control-program determination process S1, the process operation table 2 (FIG. 2) and the piping-diagram data 3 (FIG. 3) for the controlled apparatus 1002 are determined. For example, if there is a plurality of controlled apparatuses, a controlled apparatus for which the control program is generated is determined. In addition, if the controlled apparatus can perform a plurality of types of work, a type of work that the controlled apparatus performs is determined.

Specifically, the user interface portion 4 of the control-program generation system 1004 causes the display portion 100 to display the data reading screen 42 (FIG. 4). Then, a user inputs information in the process-operation-data-path input box 421 and the piping-diagram-data-path input box 422 of the data reading screen 42 by using the input portion 200, and the user interface portion 4 accepts the information. In this operation, file paths to the process operation table 2 and the piping-diagram data 3 are set, so that the controlled apparatus 1002 for which the control program is to be generated and the work of the controlled apparatus 1002 are determined.

In a flow-path setting process S2, a flow path used for a corresponding operation process of the controlled apparatus 1002 (that is, a flow path corresponding to a record in the process operation table 2) is set. For setting the flow path, the control-program generation system 1004 accepts the click to the system start button 428 of the data reading screen 42 (FIG. 4), and calls and executes a data reading process.

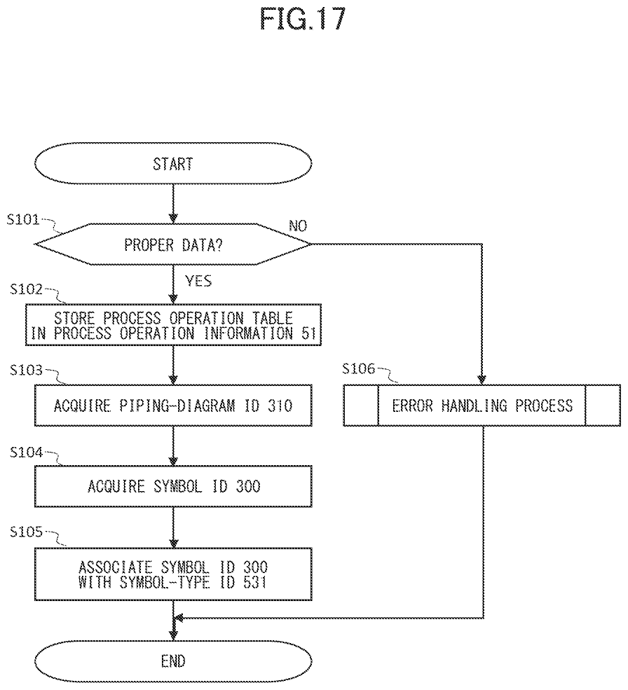

With reference to the flowchart of FIG. 17, the data reading process performed by the data management-and-generation portion 62 (FIG. 1) of the logic portion 6 will be described. In Step S101, the data management-and-generation portion 62 checks whether the process operation table 2 and the piping-diagram data 3, specified by the user, have formats that can be handled by the data management-and-generation portion 62. If the formats cannot be handled by the data management-and-generation portion 62, then the data management-and-generation portion 62 proceeds to Step S106. If the formats can be handled by the data management-and-generation portion 62, then the data management-and-generation portion 62 proceeds to Step S102.

If the data management-and-generation portion 62 proceeds to Step S106, an error handling process is performed. For example, an error dialog is displayed, or the flow path is colored with a color (e.g., red) different from a color used when the error handling process is not performed. In this manner, the data management-and-generation portion 62 notifies a user that the process has not been performed normally, and ends the data reading process. In Step S102, the data management-and-generation portion 62 stores the process operation table 2 in the process operation information 51 of the data portion 5, and proceeds to Step S103.

In Step S103, the data management-and-generation portion 62 acquires a piping diagram 35 and a piping-diagram ID 310 stored in the piping-diagram data 3, stores the piping diagram 35 and the piping-diagram ID 310 in a diagram management information (not illustrated) of the data portion 5 while associating the piping diagram 35 with the piping-diagram ID 310, and proceeds to Step S104. In Step S104, the data management-and-generation portion 62 acquires the symbol ID 300 given to each symbol 532 of the piping-diagram data 3, and proceeds to Step S105.

In Step S105, the data management-and-generation portion 62 associates the symbol ID 300 acquired in Step S104, with a corresponding symbol-type ID 531. Specifically, the data management-and-generation portion 62 uses a figure of each symbol 532 of the piping-diagram data 3 (FIG. 3), searches for a record of the symbol type information 53 (FIG. 10) that includes the symbol 532, and acquires the symbol-type ID 531 of the record. Then the data management-and-generation portion 62 associates the symbol ID 300 acquired in Step S104, with the symbol-type ID 531 acquired; stores the symbol ID 300 and the symbol-type ID 531 in the symbol information 58; and ends the data reading process.

After the data reading process is completed by the data management-and-generation portion 62, the user interface portion 4 causes the display portion 100 to display the program-output setting screen 400 (FIG. 5). Then a user sets the flow-path ID 512 for each record of the process operation information 51 displayed on the program-output setting screen 400. For example, when the flow-path ID 512 for a record whose operation order 201 is 5 is set, the user clicks the flow-path setting button 401 of the record. Then the user interface portion 4 causes the display portion 100 to display the diagram selecting screen 44 (FIG. 6). The user inputs the piping-diagram ID 310 of a piping diagram in which a flow path is to be set. After inputting the piping-diagram ID 310 in the diagram-ID input box 441, the user clicks the diagram-selection completion button 442. The user interface portion 4 accepts the click to the diagram-selection completion button 442, refers to the diagram management information, and causes the display portion 100 to display the piping diagram 35 with the specified piping-diagram ID 310, on the flow-path setting screen 41 (FIG. 7).

Next, an operation for a user to set a flow path will be described with reference to FIGS. 18A and 18B. A user sets a portion (i.e., flow path) of the flow-path structure used for an operation process specified by the piping-diagram ID 310, by using the flow-path setting screen 41. For example, in a case where a flow path from SYM 1 to SYM 3 is set as a flow path 30, the user first clicks the flow-path-formation start button 412. Then the user specifies the flow path 30 by moving a cursor 10 by using a pointing device (e.g., mouse) of the input portion 200 and dragging the cursor 10 from SYM 1 to SYM 3. The user interface portion 4 makes it easier for a user to visually recognize the flow path 30 specified by using the pointing device, by making the flow path 30 thicker or changing the color of the flow path 30.

FIG. 18A illustrates a state where a part of the flow path 30 from SYM 1 to SYM 3 is being formed graphically on the display portion 100. FIG. 18B illustrates a state where the graphic formation of the flow path 30 from SYM 1 to SYM 3 is completed on the display portion 100. After the desired flow path is formed, the user clicks the flow-path-formation end button 413, and then clicks the flow-path-setting completion button 414 for fixing the flow path 30. In this manner, a user can set an optimum flow path 30 while visually checking the flow path 30. Thus, a user can easily set an optimum flow path. Note that in FIGS. 18A and 18B, the flow path 30 and the piping-diagram ID 310, which is operation-process identifying information, are displayed on the display portion 100 substantially simultaneously with each other (the piping-diagram ID 310 is displayed as “diagram ID: 3”). Thus, a user can visually recognize which process of a plurality of operation processes corresponds to the flow path that has been set Although the flow path 30 and the operation-process identifying information are preferably displayed substantially simultaneously with each other, the flow path 30 and the operation-process identifying information may not necessarily be displayed substantially simultaneously with each other. In addition, itis preferable that the operation-process identifying information be displayed with a color different from a color of the flow path 30. In addition, it is preferable that the operation-process identifying information be displayed in an area smaller than an area in which the flow path 30 is displayed, so as not to interfere with the formation of the flow path performed by a user.

After the user interface portion 4 accepts the operation of the user, the data management-and-generation portion 62 generates the flow-path information 55 (FIG. 9) in accordance with the fixed flow path 30. Note that although the flow path is set by the operation of a user in the present embodiment, the flow path may be set in a different manner. For example, the data management-and-generation portion 62 may read the information on the setting of the flow path, and fix the whole of the flow path 30. In another case, the data management-and-generation portion 62 may read the information on the setting of a part of the flow path 30, performed by a user in advance and illustrated in FIG. 18A; and fix the flow path 30 by automatically generating the rest of the flow path 30 as illustrated in FIG. 18B. In another case, the data management-and-generation portion 62 may display only the start point and the end point of the flow path 30, and after that, the flow path 30 may be set such that the start point and the end point are interpolated by a user.

With reference to the flowchart of FIG. 19, processes for generating the flow-path information 55 (FIG. 9) will be described. In Step S201, the data management-and-generation portion 62 gives a flow-path ID 512 to the flow path 30 that has been set by a user. In Step S202, the data management-and-generation portion 62 acquires from the symbol information 58 the symbol ID 300 of all symbols 532 that exist on the flow path 30, and stores the symbol ID 300 as the setting symbol ID 552 of the flow-path information 55 (FIG. 9).

In Step S203, the data management-and-generation portion 62 calculates a difference group between the setting-symbol ID 552 (FIG. 9) stored in Step S202 and the setting-symbol ID 552 associated with the previous flow-path ID 512. Then the data management-and-generation portion 62 extracts newly-added symbols, and stores the newly-added symbols as the added-symbol ID 553. For example, the setting-symbol ID 552 of the flow-path information 55 associated with the flow-path ID 512 of 4 is SYM 1, SYM 4, SYM 7, SYM 6, and SYM 3. The previous setting-symbol ID 552, that is, the setting-symbol ID 552 of the flow-path information 55 associated with the flow-path ID 512 of 3 is SYM 2, SYM 5, SYM 8, SYM 6, and SYM 3. Since SYM 1, SYM 4, and SYM 7 exist in only the setting-symbol ID 552 associated with the flow-path ID 512 of 4, the added-symbol ID 553 is SYM 1, SYM 4, and SYM 7.

In Step S204, the data management-and-generation portion 62 calculates a difference group between the setting-symbol ID 552 stored in Step S202 and the setting-symbol ID 552 associated with the previous flow-path ID 512. Then the data management-and-generation portion 62 extracts deleted symbols, and stores the deleted symbols as the deleted-symbol ID 554. For example, in comparison between the setting-symbol ID 552 of the flow-path information 55 associated with the flow-path ID 512 of 4 and the setting-symbol ID 552 associated with the flow-path ID 512 of 3, the deleted-symbol ID 554 is SYM 2, SYM 5, and SYM 8. In this manner, by performing the flow of FIG. 19 as described above, Step S2 of the flowchart of FIG. 16, which is the flow-path setting process, is completed.

Next, in the input/output address setting process S3 (FIG. 16), the input/output address of the PLC is given to an input/output signal of a symbol 532 that is involved with a control signal. A user clicks the input/output-signal setting button 402 of the program-output setting screen 400 (FIG. 5) displayed on the display portion 100. When the control-program generation system 1004 accepts the click, the control-program generation system 1004 causes the display portion 100 to display the input/output-signal setting screen (FIG. 8). Then the data management-and-generation portion 62 executes the input/output-signal generation process that generates the input/output signal information 52.

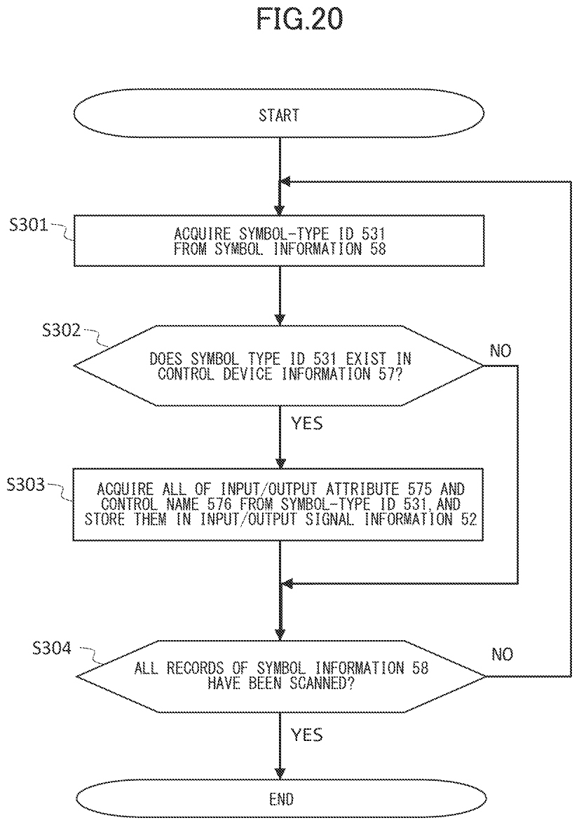

With reference to the flowchart of FIG. 20, the input/output-signal generation process will be described. In Step S301, the data management-and-generation portion 62 acquires the symbol-type ID 531 stored in each record of the symbol information 58 (FIG. 11).

In Step S302, the data management-and-generation portion 62 searches for a record of the control device information 57 in which the symbol-type ID 531 acquired in Step S301 is equal to the symbol-type ID 531 stored in the control device information 57 (FIG. 14). If such a record does not exit, then the data management-and-generation portion 62 proceeds to Step S304, and checks whether the data management-and-generation portion 62 has performed the process on all the records of the symbol information 58 (FIG. 11). If the data management-and-generation portion 62 has not performed the process on all the records, then the data management-and-generation portion 62 returns to Step S301, and performs the process on the next record. If the data management-and-generation portion 62 determines in Step S304 that the data management-and-generation portion 62 has performed the process on all the records, then the data management-and-generation portion 62 ends the input/output-signal generation process.

If the data management-and-generation portion 62 finds a record of the control device information 57, in Step S302, in which the symbol-type ID 531 acquired in Step S301 is equal to the symbol-type ID 531 stored in the control device information 57, then the data management-and-generation portion 62 proceeds to Step S303, and acquires all of the input/output attribute 575 and the control name 576 from a record of the control device information 57, which has been found in Step S302. The data management-and-generation portion 62 stores the acquired input/output attribute 575 and control name 576 in the input/output signal information 52 (FIG. 8), proceeds to Step S304, and checks whether the data management-and-generation portion 62 has performed the process on all the records of the symbol information 58 (FIG. 11).

After the input/output-signal generation process illustrated in FIG. 20 is completed, the user interface portion 4 displays the input/output-signal setting screen 43 on the display portion 100, and displays the generated input/output signal information 52 for a user. The user inputs a desired device address 70 into the displayed input/output signal information 52, by using the input portion 200. When the input/output-signal-setting completion button 431 is clicked, the data management-and-generation portion 62 stores the inputted device address 70 in the input/output signal information 52 of the data portion 5. Thus, by performing the flow of FIG. 20 as described above, Step S3 of the flowchart of FIG. 16, which is the input/output address setting process, is completed.

Finally, in Step S4 that is the control-program generation process, the control program information 59 is generated. When a user clicks the program output button 403 of the program-output setting screen 400 (FIG. 5), the control-program generation portion 61 executes the control-program generation process.

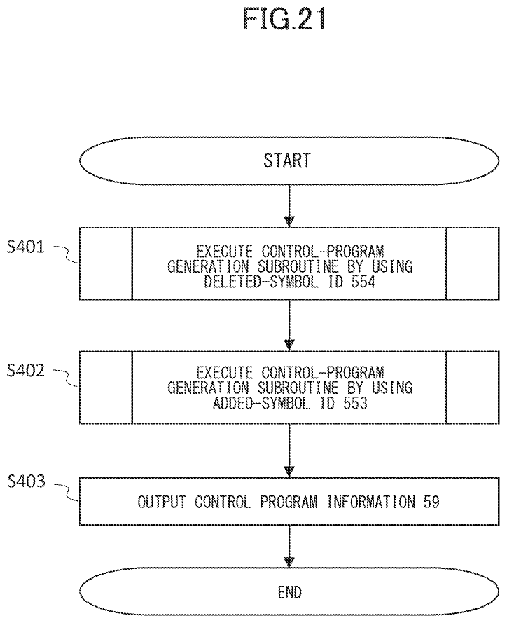

With reference to the flowchart of FIG. 21, the control-program generation process will be described. In Step S401, the control-program generation portion 61 sets an internal flag F1 for using the deleted-symbol ID 554 in a process that uses the differential-symbol ID 555 of the flow-path information 55 (FIG. 9), and calls a control-program generation subroutine. With reference to the sub-flowchart of FIG. 22, the control-program generation subroutine will be described.

In the control-program generation subroutine, in Step S501, the control-program generation portion 61 acquires all information stored in the input/output signal information 52. In Step S502, the control-program generation portion 61 acquires the operation time 203 and the flow-path ID 512 according to the operation order 201 of the process operation information 51 (FIG. 5).

In Step S503, the control-program generation portion 61 searches for a record of the flow-path information 55 (FIG. 9) in which the flow-path ID 512 is equal to the flow-path ID 512 acquired in Step S502. Then the control-program generation portion 61 acquires the symbol ID 582 stored in the differential-symbol ID 555 of the record. In a case where the internal flag F1 is set in Step S401, the control-program generation portion 61 acquires the symbol ID 582 stored as the deleted-symbol ID 554 of the differential-symbol ID 555. In a case where the internal flag F1 is not set, the control-program generation portion 61 acquires the symbol ID 582 stored as the added-symbol ID 553 of the differential-symbol ID 555.

In Step S504, the control-program generation portion 61 searches for a record of the symbol information 58 (FIG. 11) in which the symbol ID 582 is equal to the symbol ID 582 acquired in Step S503. Then the control-program generation portion 61 acquires the symbol-type ID 531 stored in the record.

In Step S505, the control-program generation portion 61 checks whether the symbol-type ID 531 acquired in Step S504 is stored in the control device information 57 (FIG. 14). The control-program generation portion 61 proceeds to Step S506 if the symbol-type ID 531 acquired in Step S504 is stored in the control device information 57, and proceeds to a later-described step S510 if the symbol-type ID 531 acquired in Step S504 is not stored in the control device information 57.

In Step S506, the control-program generation portion 61 searches for a record of the control device information 57 in which the symbol-type ID 531 is equal to the symbol-type ID 531 acquired in Step S504. Then the control-program generation portion 61 acquires the program-component ID 572 stored in the record. Note that in a case where the internal flag F1 is set in Step S401, the control-program generation portion 61 acquires the program-component ID 572 stored in the used-in-path-deletion ID 574. In contrast, in a case where the internal flag F1 is not set in Step S401, the control-program generation portion 61 acquires the program-component ID 572 stored in the used-in-path-addition ID 573.

In Step S507 that follows Step S506, the control-program generation portion 61 searches for a record of the program component information 56 in which the program-component ID 572 is equal to the program-component ID 572 acquired in Step S506. Then the control-program generation portion 61 acquires the program template 561 stored in the record.

In Step S508, the control-program generation portion 61 executes the device-address setting subroutine for setting the device address 70 to the symbol ID 582 acquired in S503 and the program template 561 acquired in S507, by using the input/output signal information 52 acquired in S501 and the operation time 203 acquired in Step S502.

With reference to the sub-flowchart of FIG. 23, the device-address setting subroutine will be described. In Step S601, the control-program generation portion 61 acquires the device address 70 of a record of the sequence-device information 540 (FIG. 12) in which the sequence attribute 542 is “Current”. Then the control-program generation portion 61 sets the device address 70 to the current sequence device 562 of the program template 561 (FIG. 13).

In Step S602, the control-program generation portion 61 acquires the device address 70 of a record of the sequence-device information 540 (FIG. 12) in which the sequence attribute 542 is “Next”. Then the control-program generation portion 61 sets the device address 70 to the next-time device address 563 of the program template 561 (FIG. 13).

In Step S603, the control-program generation portion 61 increments “Next” and “Current” of the sequence attribute 542 of the sequence-device information 540 (FIG. 12). For example, if “Current” and “Next” are respectively set for the sequence ID 13 and 14, they are set for the sequence ID 14 and 15.

In Step S604, the control-program generation portion 61 checks whether the program template 561 includes the timer device 564. Then the control-program generation portion 61 proceeds to Step S605 if the program template 561 includes the timer device 564, and proceeds to a later-described step S608 if the program template 561 does not include the timer device 564.

In Step S605, the control-program generation portion 61 acquires the device address 70 of a record of the timer-device information 543 (FIG. 12) in which the timer attribute 545 is “Current”. Then the control-program generation portion 61 sets the device address 70 to the timer device 564 of the program template 561 (FIG. 13).

In Step S606 that follows Step S605, the control-program generation portion 61 sets the operation time 203 to a timer setting value of the timer device 564 that is set in Step S605. In Step S607, the control-program generation portion 61 increments “Current” of the timer attribute 545 of the timer-device information 543.

In Step S608, the control-program generation portion 61 searches the symbol ID 582 and the control-signal ID 577 of the input/output signal information 52 (FIG. 8) for the control-signal ID 577 included in the program template 561 (FIG. 13), and acquires and sets the device address 70. In Step S609, the control-program generation portion 61 outputs the program template 561, to which the device address 70 has been set, to the control-program generation subroutine (Step S508 in FIG. 22), and ends the process.

After the above-described device-address setting subroutine (FIG. 23) is completed, the control-program generation subroutine (FIG. 22) proceeds to Step S509, and the control-program generation portion 61 stores the output obtained in Step S508, in the control program information 59.

In Step S510, the control-program generation portion 61 checks whether to have performed the steps S504 to S510 on all of the symbol IDs 582 of the differential-symbol ID 555 acquired in Step S503.

If there is a symbol ID 582 on which the control-program generation portion 61 has still not performed the steps S504 to S510, then the control-program generation portion 61 proceeds to Step S504, and performs the above-described steps on the symbol ID 582. The control-program generation portion 61 returns from Step S510 to Step S504 unless the control-program generation portion 61 has performed the steps S504 to S510 on all of the symbol IDs 582. After the control-program generation portion 61 has performed the steps S504 to S510 on all of the symbol IDs 582, the control-program generation portion 61 ends the control-program generation subroutine, and returns to the control-program generation process (FIG. 21). That is, the control-program generation portion 61 completes Step S401 of the control-program generation process (FIG. 21), and proceeds to Step S402.

In Step S402, the control-program generation portion 61 sets the internal flag F1 for using the added-symbol ID 553 in a process that uses the differential-symbol ID 555 of the flow-path information 55, and calls and executes the control-program generation subroutine (FIG. 22). The control-program generation subroutine is executed as in the above-described Step S401.

After the completion of Step S402, the control-program generation portion 61 proceeds to Step S403, and stores the control program information 59, which is a product, in the data portion 5. Then, the control-program generation portion 61 generates the control program file 1000, into which the control program information 59 is converted and which has a format that can be executed by the PLC 1001; and outputs the control program file 1000 to the external device.

As described above, in the present embodiment, a worker can easily set a flow path for a corresponding process performed by the apparatus that has a flow-path structure. In addition, the control-program generation system 1004 can output the control program information 59 by using the process operation table 2 in which a series of operation processes to be executed by a controlled apparatus is written, and using the piping-diagram data 3 in which the flow path 30 associated with a corresponding operation process is written.

### MODIFICATION

In the above-described embodiment, an operation of a controlled device, such as an operation of a valve from an open state to a close state, is performed once in an operation process. However, depending on an operation process, the state of a symbol 532 that represents a corresponding controlled device may change with time in the operation process. Examples of such an operation include an operation (intermittent operation) in which a valve is repeatedly opened and closed at regular intervals for preventing water condensation, and an operation (delay operation) in which a valve is opened with intentional delay for preventing the flow rate from rapidly increasing, for preventing water hammer phenomenon. Thus, by allowing a user to visually recognize the state transition information on a controlled device (such as the information on the opening and closing of a valve) when the flow path 30 is set, the convenience for users can be increased. Hereinafter, some modifications thereof will be described.

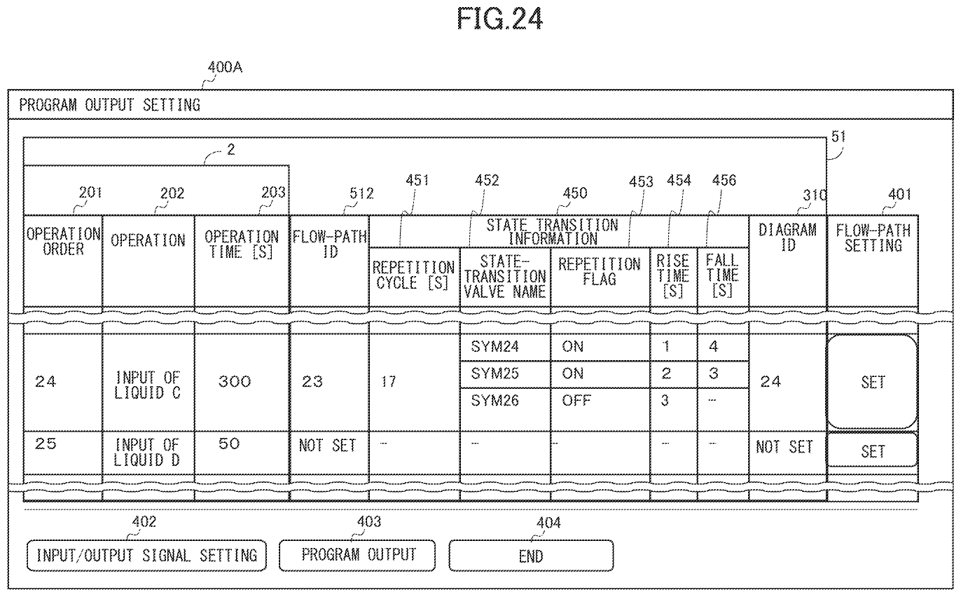

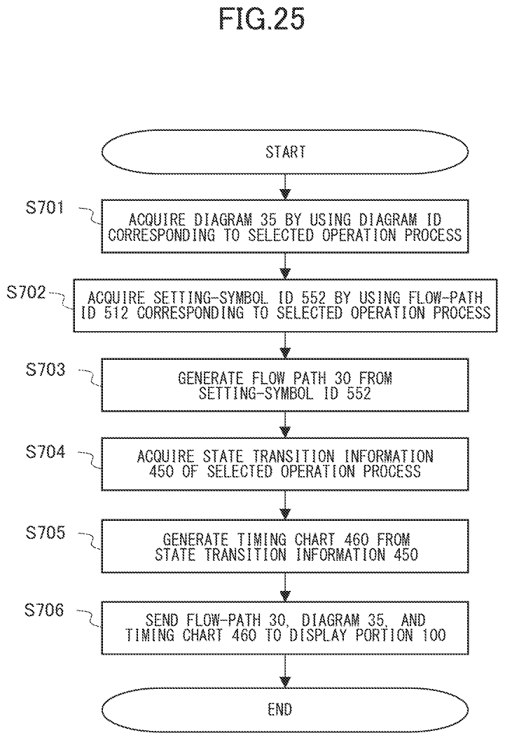

FIG. 24 illustrates a program-output setting screen 400A in which a state transition information is further included in the process operation information 51. The state transition information represents the state transition of the symbol 532, performed in each operation process. A state transition information 450 includes a repetition cycle 451, a state-transition valve name 452, a repetition flag 453, a rise time 454, and a fall time 456. The repetition cycle 451 is a unit time of repetition of the state transition. The state-transition valve name 452 is the symbol ID 532 of a valve whose state transitions in an operation process. The repetition flag 453 is a flag indicating whether the state transition is repeated after the repetition cycle 451 has elapsed. The rise time 454 is a time when a valve is opened. Specifically, when an operation-process execution time 204 (not illustrated) indicating the elapsed time in an operation process becomes equal to the rise time 454, the valve is opened. Similarly, the fall time 456 is a time when a valve is closed. Specifically, when the operation-process execution time 204 becomes equal to the fall time 456, the valve is closed. The state transition information 450 may be set on the program-output setting screen 400A, or may be set on another setting screen. For example, if a flow-path setting button 401 disposed in a line with an operation order 201 of 24 is pressed, a flow-path-and-timing-chart formation flowchart illustrated in FIG. 25 is executed.

Next, the flow-path-and-timing-chart formation flowchart of FIG. 25 will be described in the order of step numbers. In Step S701, the information processing apparatus acquires a piping-diagram ID 310 included in a line that includes a flow-path setting button 401 that a user has pressed, and acquires a piping diagram 35 from the piping-diagram data 3 for forming the flow path 30. In Step S702, the information processing apparatus acquires setting-symbol IDs 552 from the flow-path information 55, by using a flow-path ID 512 included in the line that includes the flow-path setting button 401 that the user has pressed. In Step S703, the information processing apparatus generates the flow path 30 as graphic formation data that connects the setting symbol IDs 552 acquired in Step S702. In Step S704, the information processing apparatus acquires a state transition information 450 included in the line that includes the flow-path setting button 401 that the user has pressed.

In Step S705, the information processing apparatus generates a timing chart 460 from the state transition information 450 acquired in Step S704. Specifically, the information processing apparatus forms a timing line 463 that transitions from a close state to an open state at a timing of the rise time 454 in the state transition information, and that transitions from the open state to the close state at a timing of the fall time 456. When the timing chart 460 is formed, a time at which the state transition occurs is also displayed as a time label 465. In addition, the information processing apparatus also displays the repetition cycle 451 as the time label 465. In addition, the information processing apparatus displays a repetition mark 464 for a valve whose repetition flag 453 is ON, for indicating that after the repetition cycle 451 has elapsed, the operation-process execution time 204 will be reset and the state transition will occur again.

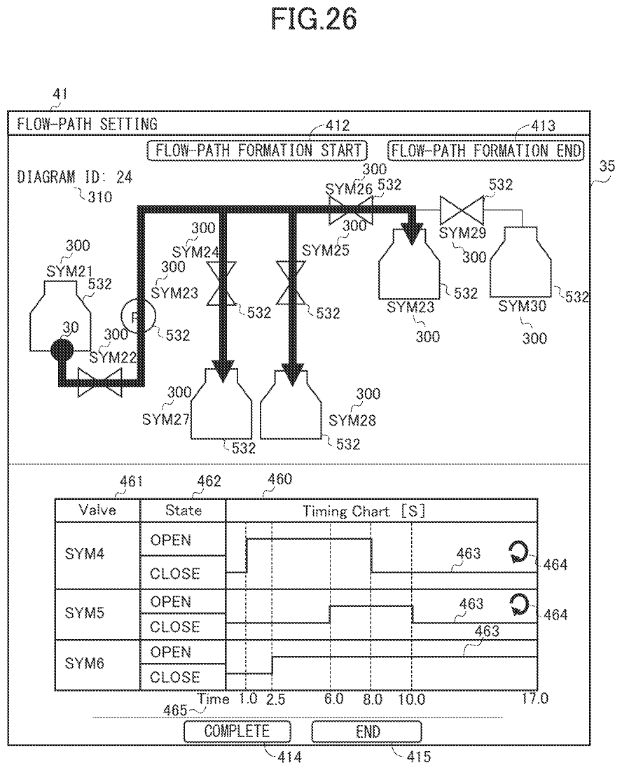

Finally, in Step S706, the information processing apparatus combines the generated flow path 30 and the acquired piping diagram 35, and sends the flow path 30, the piping diagram 35, and the timing chart 460 generated in S705, to the display portion. As a result, as illustrated in FIG. 26, the flow path 30 and the timing chart 460 can be displayed on the flow-path setting screen 41 substantially simultaneously with each other.

Note that although the information processing apparatus causes the display portion to display the state transition information as a timing chart in the present embodiment, the method of displaying the state transition information is not limited to the above-described method. For example, the state transition information may be displayed on the background of the flow-path setting screen 41, or may be expressed by using animation, such as blink or movement of a flow path or a symbol. Although it is preferable that the state transition information be set together with the flow path 30, the state transition information may not necessarily be set together with the flow path 30. In addition, it is preferable that the state transition information be displayed with a color different from a color of the flow path 30. In addition, it is preferable that the state transition information be displayed in an area smaller than an area in which the flow path 30 is displayed, so as not to interfere with the formation of the flow path performed by a user. In the present embodiment, the symbol 532 that is involved with the state transition is only a valve, and the state transition information 450 is limited to the information on the intermittent operation and the delay operation. However, the present disclosure is not limited to this. For example, types of the state transition information may be increased, and the types of the state transition information may be associated with respective types of the symbol 532.

Note that the present invention is not limited to the above-described embodiments, and can be variously modified within the technical concept of the present invention. For example, the screen displayed by the display portion in each process of the program generation process is not limited to the screens illustrated in the drawings, and may be changed as appropriate as long as the screen can achieve the aim of each process.

The program generation system and the program generation method of the present invention can be used, without any particular limitation, for generating a control program that operates an apparatus including a flow-path structure, which includes controlled components (controlled devices) such as a pump and a valve.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-28076, filed Feb. 25, 2021, and Japanese Patent Application No. 2022-3582, filed Jan. 13, 2022 which are hereby incorporated by reference herein in their entirety.

What is claimed is:

1. An information processing apparatus comprising:
a display portion;
a storage portion; and
a processing portion,
wherein the processing portion is configured to
display an operation-process identifying information that indicates an operation process of a plurality of operation processes, and a figure information that represents a flow-path structure, on the display portion,
display a flow-path portion used as a flow path of the flow-path structure in an operation process indicated by the operation-process identifying information, on the display portion by using the figure information, and
associate the flow-path portion with the operation-process identifying information and store the flow-path portion associated with the operation-process identifying information, in the storage portion, as flow-path setting information.

2. The information processing apparatus according to claim 1, further comprising an input portion,
wherein the processing portion is configured to acquire information on the flow-path portion to be set via the input portion while displaying the figure information that represents the flow-path structure, on the display portion, and
wherein the flow-path portion is used as a flow path of the flow-path structure in an operation process indicated by the operation-process identifying information.

3. The information processing apparatus according to claim 1, wherein the processing portion is configured to display the flow-path portion used as a flow path of the flow-path structure in an operation process indicated by the operation-process identifying information, substantially simultaneously with the operation-process identifying information and the figure information.

4. The information processing apparatus according to claim 3, wherein the processing portion is configured to
acquire information on a controlled device disposed in the flow-path structure, and
display state transition information on the controlled device in an operation process indicated by the operation-process identifying information, substantially simultaneously with the flow-path portion, the operation-process identifying information, and the figure information.

5. The information processing apparatus according to claim 4, wherein the processing portion is configured to display the state transition information on the controlled device, as a timing chart.

6. The information processing apparatus according to claim 1, wherein the processing portion is configured to generate a control program that causes a control apparatus to execute the plurality of operation processes, by using the flow-path setting information.

7. The information processing apparatus according to claim 6, wherein the processing portion is configured to
acquire information on a controlled device disposed in the flow-path structure, and
generate a program, as the control program, configured to be interpreted by the control apparatus that controls the controlled device.

8. The information processing apparatus according to claim 7, wherein the control apparatus is a programmable logic controller, and the control program is a ladder program configured to be interpreted by the programmable logic controller.

9. The information processing apparatus according to claim 4, wherein the controlled device is one of a pump and a valve.

10. The information processing apparatus according to claim 6, wherein the information processing apparatus is configured to output the generated control program to the control apparatus.

11. A control apparatus configured to read the control program from the information processing apparatus according to claim 6 and execute the plurality of operation processes.

12. A control method comprising:
acquiring, by a computer, information on a flow-path structure of a controlled apparatus and information on a plurality of operation processes executed by the controlled apparatus;
displaying, by the computer, figure information that represents the flow-path structure, on a display portion; and
storing, by the computer, a flow-path portion as flow-path setting information for each of a plurality of operation processes executed by the controlled apparatus, the flow-path portion being used as a flow path of the flow-path structure.

13. The control method according to claim 12, wherein the computer accepts setting of a flow-path portion while displaying figure information that represents the flow-path structure, on the display portion, and stores the flow-path portion as flow-path setting information,
wherein the setting is performed by a user, and
wherein the flow-path portion is used as a flow path of the flow-path structure, for each of the plurality of operation processes executed by the controlled apparatus.

14. The control method according to claim 13, further comprising:
acquiring, by the computer, information on a controlled device disposed in the flow-path structure; and
generating, by the computer, a program, as a control program, that is able to be interpreted by a control apparatus that controls the controlled device.

15. The control method according to claim 14, wherein the control apparatus is a programmable logic controller, and the control program is a ladder program that is able to be interpreted by the programmable logic controller.

16. The control method according to claim 14, wherein the controlled device comprises one of a pump and a valve.

17. The control method according to claim 14, wherein the generated control program is outputted to the control apparatus.

18. A method of controlling a control apparatus, comprising:
generating a control program by using the control method according to claim 12; and
causing the control apparatus to read the control program and execute the plurality of operation processes.

19. A computer-readable recording medium storing a program that causes a computer to execute the control method according to claim 12.
